(19) United States
(12) Patent Application Publication
(10) Pub. No.: US 2012/0076912 A1
(43) Pub. Date: Mar. 29, 2012

(54) PROCESS FOR PRODUCTION OF PALE-COLORED SOY SAUCE

(75) Inventors: Junko Watabe, Chiba (JP); Yasushi Inomoto, Chiba (JP)

(73) Assignee: KIKKOMAN CORPORATION, Chiba (JP)

(21) Appl. No.: 13/375,513

(22) PCT Filed: Jul. 14, 2010
(86) PCT No.: PCT/JP2010/061867

§ 371 Date: Dec. 1, 2011

(30) Foreign Application Priority Data
Jul. 24, 2009 (JP) 2009-172646

(51) Int. Cl. A23L 1/238; B82Y 99/00

(52) U.S. Cl. 426/589; 977/902

(57) ABSTRACT

Method for producing a pale-colored soy sauce, includes subjecting a soy sauce to a permeation treatment using a nano filtration membrane module having a small pore size to give a first permeated liquid and an unpermeated liquid; then subjecting the unpermeated liquid to a permeation treatment using a nano filtration membrane module having a larger pore size than that of the nano filtration membrane module to give a second permeated liquid (B); and combining both permeated liquids to obtain the pale-colored soy sauce. Preferably, two kinds of nano filtration membrane modules having different salt rejection percentages are used, such that the module having a small pore size has an a % salt rejection and the other module has a b % salt rejection, and a and b satisfy the following formulae: (1) a>b, (2) 40%≦a≦70%, (3) 5%≦b≦40%, and (4) 22≦a−b≦65.

### TECHNICAL FIELD

The present invention relates to improvement of a method for producing a pale-colored soy sauce using nano filtration membrane modules. Namely, the present invention relates to a process for obtaining a pale-colored soy sauce having an extremely high rate of amino acids while retaining the filtration amount per the unit membrane surface area and unit time of the nano filtration (hereinafter referred to as permeation flux) at a high level. Meanwhile, the rate of amino acids represents the content of free amino acids per the total content of amino acids in a soy sauce, and the higher the value thereof is, the better lasting after-taste and the stronger umami flavor derived from amino acids the soy sauce has.

### BACKGROUND ART

Conventionally, a method for obtaining a pale-colored soy sauce by subjecting a soy sauce to a permeation treatment by using a reverse osmosis membrane (also referred to as a nano filtration membrane) having a salt blocking rate of 50% or more when 0.2% brine is subjected to a permeation treatment at a temperature of 25° C. under a pressure of 30 kg/cm²·G (for example, see Patent Literature 1) is known.

However, this method aims at removing browning components, and thus is not a method for obtaining a pale-colored soy sauce having a high rate of amino acids.

Furthermore, a method for obtaining a pale-colored soy sauce having a pale color, being rich in taste and having stablizing ability of color, by subjecting a raw soy sauce to a permeation treatment by using a reverse osmosis membrane having a salt rejection percentage of 30% or less when a permeation treatment is conducted under the same conditions as mentioned above, heating the permeated liquid, and further subjecting the permeated liquid to a reverse osmosis membrane having a salt rejection percentage of from 30 to 70% (for example, see Patent Literature 2) is known.

However, this method aims at obtaining a pale-colored soy sauce having stablizing ability of color by permeating a raw soy sauce by using a reverse osmosis membrane, followed by heating the permeated liquid to polymerize browning components, and further permeating the permeated liquid by using a reverse osmosis membrane, and is not for increasing a rate of amino acids.

### CITATION LIST

### Patent Literature

Patent Literature 1: Japanese Patent No. 2866765
Patent Literature 2: Japanese Patent Application Laid-Open No. 5-41959

### SUMMARY OF INVENTION

### Technical Problem

The problem of the present invention is to readily obtain a pale-colored soy sauce having an extremely high rate of amino acids while keeping a permeation flux at a high level in obtaining a pale-colored soy sauce by subjecting a soy sauce to a permeation treatment by using a nano filtration membrane.

### Solution to Problem

The present inventors have done intensive studies for solving such problem and consequently found that the above-mentioned problem can be solved by using two kinds of nano filtration membranes having pores with the size of the pores different from each other as a nano filtration membrane for the permeation treatment of a soy sauce by using a nano filtration membrane, and by setting the order of the permeation treatments to the order of a first permeation treatment by using the nano filtration membrane having a small pore size firstly and a second permeation treatment by using the nano filtration membrane having a large pore size, and completed the present invention based on this finding.

Namely, the present invention is the following method for producing a pale-colored soy sauce.

(1) A method for producing a pale-colored soy sauce, comprising: first subjecting a soy sauce to a permeation treatment by using a nano filtration membrane module having a small pore size to give a permeated liquid (A) and an unpermeated liquid; then subjecting the unpermeated liquid to a permeation treatment by using a nano filtration membrane module having a larger pore size than that of the nano filtration membrane module having a small pore size to give a permeated liquid (B); and combining the permeated liquid (A) and the permeated liquid (B) to give the pale-colored soy sauce.

(2) The method for producing a pale-colored soy sauce according to (1), wherein the nano filtration membrane modules each have a structure containing a membrane element including a porous hollow tube and a nano filtration membrane that is wound spirally on the circumference of the porous hollow tube so as to prevent a feed side flow path and a permeation side flow path of the soy sauce from mixing each other, in which the soy sauce can be flowed from one end to other end of the membrane element and ejected outwardly.

(3) The method for producing a pale-colored soy sauce according to (1), wherein when the nano filtration membrane module having a small pore size has a salt rejection percentage of a % when brine having a concentration of 0.2 w/v % is subjected to a permeation treatment at a temperature of 25° C. under a gauge pressure of 3 MPa, and the nano filtration membrane module having a larger pore size than that of the nano filtration membrane module having a small pore size has a salt rejection percentage of b % when the brine is subjected to a permeation treatment under the same conditions, a and b satisfy the relationship of the following formulae (1) to (4):

a>b, (1)

40%≦a≦70%, (2)

5%≦b≦40%,and (3)

22≦a−b≦65. (4)

### Advantageous Effect of Invention

According to the present invention, a pale-colored soy sauce having an extremely high rate of amino acids can be readily obtained while keeping a permeation flux at a high level, in obtaining a pale-colored soy sauce by subjecting a soy sauce to the permeation treatments by using the nano filtration membranes.

### BRIEF DESCRIPTION OF DRAWING

FIG. 1 is a cross-sectional drawing that shows the outline of an example of the filtration apparatus that is preferable for carrying out the production method of the present invention.

### DESCRIPTION OF EMBODIMENTS

Hereinafter the method for producing a pale-colored soy sauce of the present invention is explained in detail.

Examples of the soy sauce to be used in the present invention may include strong soy sauces (koikuchi), light soy sauces (usukuchi), tamari soy sauces, soy sauces obtained by enzymatic decomposition of proteins, and the like, and those can be utilized as either a raw soy sauce or a heat-treated soy sauce.

As the nano filtration membrane module to be used in the present invention, any one having a salt rejection percentage of from 5 to 70% when brine having a concentration of 0.2 w/v % is subjected to a permeation treatment at a temperature of 25° C. under a gauge pressure of 3 MPa (hereinafter simply referred to as a salt rejection percentage) can be adopted. Furthermore, as the shape thereof, any of a tubular shape, a hollow fiber shape, a spiral shape, a plane membrane shape and the like can be utilized, and a structure containing a membrane element including a porous hollow tube and a nano filtration membrane that is wound spirally on the circumference of the porous hollow tube so as to prevent a feed side flow path and a permeation side flow path of the soy sauce from mixing each other, in which the soy sauce can be flowed from one end to other end of the membrane element and ejected outwardly, is preferable since the structure has a fine permeation efficiency. Specific examples may include commercial products such as NTR Series manufactured by Nitto Denko (NTR-7450, NTR-7430, NTR-7410, NTR-7250 and the like) and SU-210 manufactured by Toray.

It is important for the present invention to use two kinds of nano filtration membrane modules having pores with the size of the pores different from each other, among the above-mentioned nano filtration membrane modules, in combination, and setting the order of the permeation treatments to the order of the first permeation treatment by the nano filtration membrane module having a small pore size and the second permeation treatment by the nano filtration membrane module having a large pore size. When the order of the permeation treatments by the above-mentioned two kinds of nano filtration membrane modules is transposed (namely, the order of a first permeation treatment by the nano filtration membrane module having a large pore size and a second permeation treatment by the nano filtration membrane module having a small pore size), a pale-colored soy sauce having a high rate of amino acids cannot be obtained.

A combination of the above-mentioned two kinds of nano filtration membrane modules having pores with the size of the pores different from each other may include a combination of a nano filtration membrane module having a high salt rejection percentage and a nano filtration membrane module having a low salt rejection percentage.

A specific example of such combination of the two kinds of nano filtration membrane modules having different salt rejection percentages may include a combination of NTR-7450 manufactured by Nitto Denko, which is a nano filtration membrane module having a high salt rejection percentage, with NTR-7430 or NTR-7410 manufactured by Nitto Denko, which is a nano filtration membrane module having a lower salt rejection percentage than that of NTR-7450.

As the above-mentioned combination of the two kinds of nano filtration membrane modules having different salt rejection percentages, it is preferable that the nano filtration membrane module having a high salt rejection percentage has a salt rejection percentage a of from 40 to 70%, preferably from 40 to 60%, the nano filtration membrane module having a low salt rejection percentage has a salt rejection percentage b of from 5 to 40%, preferably from 5 to 30%, and the difference a−b between the salt rejection percentage a and the salt rejection percentage b is from 22 to 65, specifically from 22 to 55.

The filtration pressure for the permeation treatment (filtration) of the soy sauce in the present invention is suitably a gauge pressure of from 1 to 5 MPa, preferably a gauge pressure of from 2 to 5 MPa. During the permeation treatment, although the article temperature of the soy sauce may be a room temperature, it is preferably from 30 to 60° C. When the article temperature of the soy sauce is a too low temperature, the permeation efficiency is deteriorated, whereas when the temperature is a temperature higher than 60° C., it is not preferable since the product is deteriorated due to scattering of aroma components, and the like. By these permeation treatments, a pale-colored soy sauce having a JAS color lightness of about 55 can be obtained. When the permeation amount is excessive, the permeation flux is decreased significantly, and thus the permeation amount is preferably about 50 v/v % or less with respect to a soy sauce of a neat liquid.

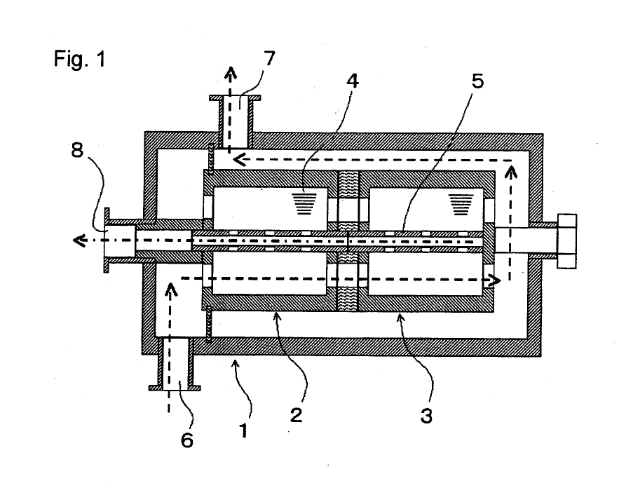

In carrying out the present invention, as a filtration apparatus using nano filtration membrane modules, a filtration apparatus such as one described in Japanese Patent No. 3597351 can be utilized. Specifically, a filtration apparatus as shown in FIG. 1 may be exemplified.

Next, the filtration apparatus of FIG. 1 is explained.

The present filtration apparatus is constituted by a filtration container 1, and two kinds of nano filtration membrane modules, 2 and 3 housed in the filtration container 1, in which each of the nano filtration membranes has pores with the size of the pores different from each other.

The nano filtration membrane module 2 having a small pore size is disposed on the upper stream side of the filtration container 1, and the nano filtration membrane module 3 having a larger pore size than that of the nano filtration membrane module 2 is disposed on the downstream side of the filtration container 1, respectively.

The nano filtration membrane module 2 has a structure containing a membrane element 4 including a permeated liquid tube (porous hollow tube) 5 and a nano filtration membrane that is wound spirally on the circumference of the permeated liquid tube so as to prevent a feed side flow path and a permeation side flow path of a raw material soy sauce from mixing each other, in which the soy sauce can be flowed from one end to other end of the membrane element 4 and ejected outwardly. The nano filtration membrane module 3 has a similar structure to that of the nano filtration membrane module 2.

The filtration container 1 has a neat liquid inlet 6 for introducing a raw material soy sauce, a concentrated liquid outlet 7 that is disposed on the opposed side of the neat liquid inlet 6, and a permeated liquid outlet 8 that is connected to the permeated liquid tube (porous hollow tube) 5.

When the present filtration apparatus is utilized, the raw material soy sauce is introduced into the filtration container 1 from the neat liquid inlet 6. The raw material soy sauce as introduced passes through the membrane element 4 of the nano filtration membrane module 2, while the soy sauce [permeated liquid (A)] that has been permeated through the nano filtration membrane is collected in the permeated liquid tube (porous hollow tube) 5, as shown by the dashed line in FIG. 1. On the other hand, the soy sauce [unpermeated liquid] that has not been permeated through the nano filtration membrane enters into the nano filtration membrane module 3 from the membrane element 4 of the nano filtration membrane module 2 and passes the membrane element 4. Meanwhile, the soy sauce [permeated liquid (B)] that has been permeated through the nano filtration membrane is collected in the permeated liquid tube (porous hollow tube) 5, as shown by the dashed line in FIG. 1. The soy sauce [the permeated liquid (A) and the permeated liquid (B)] collected in the permeated liquid tube (porous hollow tube) 5 is ejected from the permeated liquid outlet 8 as a pale-colored soy sauce.

On the other hand, the soy sauce at the concentration side [unpermeated liquid] that has not been permeated through the nano filtration membrane modules 2 and 3 is ejected from the concentrated liquid outlet 7 and introduced again from the neat liquid inlet 6 to circulate, as shown by the broken line in FIG. 1. Furthermore, if necessary, the filtration temperature can be adjusted by disposing a jacket in the filtration container 1 and passing cool water or hot water therethrough.

The components of the pale-colored soy sauce obtained in the present invention were analyzed according to the Method for Testing Soy Sauce (published by Japan Soy Sauce Research Institute, sold by Shokyo Tsushinsha, published on Mar. 1, 1985).

The rate of amino acids in the present invention was calculated as follows. First, 5 ml of a sample soy sauce was added to 5 ml of 8.5 N hydrochloric acid and heated at 110° C. for 15 hours to decompose the soy sauce into amino acids. After the decomposition, for subjecting to an amino acid analysis, neutralization was conducted by adding a suitable amount of 5 N sodium hydroxide, followed by dilution with water in a measuring cylinder to 250 ml and further dilution to 10-folds, whereby a soy sauce after amino acid decomposition was prepared. Meanwhile, 5 ml of a sample soy sauce was diluted with distilled water to 500-fold to prepare a soy sauce before amino acid decomposition.

Using an amino acid analyzer (L-8800, manufactured by Hitachi High-Technologies Corporation), the above-mentioned soy sauce after amino acid decomposition and the soy sauce before amino acid decomposition were analyzed respectively. The contents of the following 19 kinds of amino acids, which are mainly included in soy sauces, were calculated from the obtained analysis values, and the total thereof was defined as a total amino acid content. Since the total amino acid content in the soy sauce before amino acid decomposition corresponds to the free amino acid content in the soy sauce, and the total amino acid content in the soy sauce after amino acid decomposition corresponds to the total amino acid content in the soy sauce, a rate of amino acids was finally calculated from the values of the total amino acid contents of the soy sauce before and after amino acid decomposition (rate of amino acids=the total amino acid content of the soy sauce before amino acid decomposition/the total amino acid content of the soy sauce after amino acid decomposition).

19 Kinds of amino acids: Aspartic acid, Threonine, Serine, Glutamic acid, Glycine, Alanine, Cysteine, Valine, Methionine, Isoleucine, Leucine, Tyrosine, Phenylalanine, γ-Aminobutyric acid, Ornithine, Lysine, Histidine, Arginine and Proline

The thus-obtained pale-colored soy sauce retains a permeation flux at a high level, while the soy sauce has a high rate of amino acids and an extremely pale color.

### EXAMPLES

Hereinafter the present invention is specifically explained with referring to Examples.

### Example 1

### Measurement of Salt Rejection Percentages of Nano Filtration Membrane Modules

For the two kinds of nano filtration membrane modules having pores with the size of the pores different from each other to be used in the present example (NTR-7450 and NTR-7410 manufactured by Nitto Denko), salt rejection percentages were measured as follows.

Using NTR-7450 manufactured by Nitto Denko, brine having a concentration of 0.2 w/v % was subjected to a permeation treatment at a temperature of 25° C. under a gauge pressure of 3 MPa. Neat liquid brine (A), the brine (B) that had been permeated through the membrane, and the brine (C) that had not been permeated through the membrane but had been concentrated were collected, and the salt concentrations were measured respectively. From these measured values, a salt rejection percentage was calculated by using the following formula.

$$Salt rejection percentage ( \% ) = ( 1 - \frac{Concentration of brine ( B )}{( \begin{matrix}Concentration of brine ( A ) + \\ Concentration of brine ( C )\end{matrix} ) / 2} ) \times 100$$

A salt rejection percentage was obtained also for NTR-7410 in a similar manner to that of NTR-7450.

As a result of the measurements, the nano filtration membrane module having a small pore size (NTR-7450 manufactured by Nitto Denko) had a salt rejection percentage of 40.3%, and the nano filtration membrane module having a large pore size (NTR-7410 manufactured by Nitto Denko) had a salt rejection percentage of 16.2%.

(Filtration Apparatus for Soy Sauce)

The filtration apparatus shown in FIG. 1 was used. In FIG. 1, NTR-7450 manufactured by Nitto Denko having a salt rejection percentage of 40.3% was used as the nano filtration membrane module having a small pore size 2 to be disposed on the upper stream side, and NTR-7410 manufactured by Nitto Denko having a salt rejection percentage of 16.2% was used as the nano filtration membrane module having a large pore size 3 to be disposed on the downstream side.

(Production of the Pale-Colored Soy Sauce of the Present Invention)

100 L of a heat-treated strong soy sauce (nitrogen concentration: 1.6 w/v %, color lightness: 12) was introduced from the neat liquid inlet 6 of the above-mentioned filtration apparatus at a gauge pressure of 3 MPa and a flow amount of 10 L/minute, membrane treatments were performed until the amount of the permeated liquid became 50 L to give a pale-colored soy sauce. Meanwhile, the membrane surface areas of the nano filtration membrane modules on the upper stream side and downstream side were the same, 6.8 m².

### Comparative Example 1

A pale-colored soy sauce was obtained in a similar manner to that of Example 1, except that the order of the two kinds of the nano filtration membrane modules used in Example 1 was transposed, i.e., a filtration apparatus in which NTR-7410 manufactured by Nitto Denko having a salt rejection percentage of 16.2% had been disposed on the upper stream side and NTR-7450 manufactured by Nitto Denko having a salt rejection percentage of 40.3% had been disposed on the downstream side was used for comparison.

### Comparative Example 2

A pale-colored soy sauce was obtained in a similar manner to that of Example 1, except that a filtration apparatus in which NTR-7450 manufactured by Nitto Denko having a salt rejection percentage of 40.3% had been disposed on both of the upper stream side and downstream side was used for comparison.

The measurement results of the salt rejection percentages of the nano filtration membrane modules on the upper stream side and downstream side used in Example 1, Comparative Example 1 and Comparative Example 2, the average permeation fluxes of Example 1, Comparative Example 1 and Comparative Example 2, and the nitrogen concentrations, rate of amino acids and color lightnesses of the pale-colored soy sauces obtained in Example 1, Comparative Example 1 and Comparative Example 2 are shown in Table 1.

TABLE 1

| | Salt rejection percentage (%) | | Average permeation | Nitrogen | Rate of | |
|---|---|---|---|---|---|---|
| | Upper stream | Downstream | flux | concentration | amino acids | Color |
| Kind | side | side | (L/m²/h) | (w/v %) | (%) | lightness |
| Example 1 | 40.3 | 16.2 | 7.6 | 1.19 | 92.0 | 55 |
| Comparative Example 1 | 16.2 | 40.3 | 7.9 | 1.19 | 87.1 | 55 |
| Comparative Example 2 | 40.3 | 40.3 | 3.8 | 1.10 | 90.6 | 57 |

From the results of Table 1, it is found that only a pale-colored soy sauce having rate of amino acids of 87.1% can be obtained when the nano filtration membrane module having a large pore size (NTR-7410 manufactured by Nitto Denko having a salt rejection percentage of 16.2%) is used on the upper stream side and the nano filtration membrane module having a small pore size (NTR-7450 manufactured by Nitto Denko having a salt rejection percentage of 40.3%) is used on the downstream side as in Comparative Example 1.

Furthermore, it is found that the permeation flux is 3.8 L/m²/h that is decreased to half of 7.6 L/m²/h in the case of Example 1, and thus the permeation efficiency is deteriorated when the nano filtration membrane modules having the same pore sizes (NTR-7450 manufactured by Nitto Denko having a salt rejection percentage of 40.3%) are used in connection on the upper stream side and downstream side as in Comparative Example 2.

On the other hand, it is found that a pale-colored soy sauce having rate of amino acids of 92.0% that is about 5% higher than that of Comparative Example 1 can be obtained at a similar permeation flux to that in the case in Comparative Example 1 when the nano filtration membrane module having a small pore size (NTR-7450 manufactured by Nitto Denko having a salt rejection percentage of 40.3%) is used on the upper stream side and the nano filtration membrane module having a large pore size (NTR-7410 manufactured by Nitto Denko having a salt rejection percentage of 16.2%) is used on the downstream side as in Example 1.

### DESCRIPTION OF THE REFERENCE NUMERAL

1: filtration container
2: nano filtration membrane module on upper stream side
3: nano filtration membrane module on downstream side
4: membrane element
5: permeated liquid tube (porous hollow tube)
6: neat liquid inlet
7: concentrated liquid outlet
8: permeated liquid outlet

1. A method for producing a pale-colored soy sauce, comprising:
first subjecting a soy sauce to a permeation treatment by using a nano filtration membrane module having a small pore size to give a permeated liquid (A) and an unpermeated liquid;
then subjecting the unpermeated liquid to a permeation treatment by using a nano filtration membrane module having a larger pore size than that of the nano filtration membrane module having a small pore size to give a permeated liquid (B); and
combining the permeated liquid (A) and the permeated liquid (B) to give the pale-colored soy sauce.

2. The method for producing a pale-colored soy sauce according to claim 1,
wherein the nano filtration membrane modules each have a structure containing a membrane element including a porous hollow tube and a nano filtration membrane that is wound spirally on the circumference of the porous hollow tube so as to prevent a feed side flow path and a permeation side flow path of the soy sauce from mixing each other, in which the soy sauce can be flowed from one end to other end of the membrane element and ejected outwardly.

3. The method for producing a pale-colored soy sauce according to claim 1,
wherein when the nano filtration membrane module having a small pore size has a salt rejection percentage of a % when brine having a concentration of 0.2 w/v % is subjected to a permeation treatment at a temperature of 25° C. under a gauge pressure of 3 MPa, and the nano filtration membrane module having a larger pore size than that of the nano filtration membrane module having a small pore size has a salt rejection percentage of b % when the brine is subjected to a permeation treatment under the same conditions, a and b satisfy the relationship of the following formulae (1) to (4):
a>b, (1)
40%≦a≦70%, (2)
5%≦b≦40%,and (3)
22≦a−b≦65. (4)
